(19) United States
(12) Patent Application Publication
(10) Pub. No.: US 2011/0243638 A1
(43) Pub. Date: Oct. 6, 2011

(54) Mechanical Shading Pencil with Rotating Lead

(76) Inventor: Israel Jimenez, Fort Worth, TX (US)

(21) Appl. No.: 12/754,413

(22) Filed: Apr. 5, 2010

(51) Int. Cl. B43K 21/00

(52) U.S. Cl. 401/49

(57) ABSTRACT

The invention is a mechanical shading pencil where the lead rotates within the pencil casing, either on the lead's axis, or with an eccentric movement, such that the pencil will shade an area of a surface though the user is moving the pencil in a straight line.

### CROSS-REFERENCE TO RELATED APPLICATIONS

None

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### BACKGROUND OF THE INVENTION

(1) Field of the Invention

The present invention pertains to mechanical pencils.

(2) Description of the Related Art Including Information Disclosed Under 37 CFR 1.97 and 1.98

Shading pencils are well known to those with ordinary skill in the art. Existing shading pencils from prior art come in many sizes, shapes and lead diameter. The lead shafts found in shading pencils are often round, but are also offered in other shapes, to allow a user to change the effect of the pencil's movement on a surface by changing the way that the pencil is held, or to allow a user to shade an area by using a pencil lead that starts off with a relatively wider cross-sectional area in contact with the canvas or other surface than the commonly used round lead shafts.

Mechanical pencils are also known in the art, comprising features and abilities which allow the lead to be fed either automatically or upon a user's action, allowing the pencil to maintain a constant length, rather than be slowly ground down and shortened each time the lead is sharpened.

A challenge for artists is shade only a targeted area. Shading typically includes repeated rapid movement of the shading pencil over the area to be shaded. During this rapid movement, even skilled artists can cover more surface than intended, doing damage to a work of art that requires an eraser to repair.

Drafters and artists are taught to rotate pencils as they work, keeping consistency in line width and darkness. If a drafter does not rotate his pencil lead, the line will slowly widen, created unwanted changes in a drawing.

Another challenge for artists using shading pencils is to maintain a constant shade. To create a shaded area with an unvarying shade, a user must maintain an unchanging pressure of pencil lead on the targeted surface. Artists struggle to maintain constant lead pressure while moving the pencil over an area when the artists hand must change position.

What is needed is a mechanical pencil that allows an artist to a) shade an area without rapid hand movement, b) rotate the pencil lead during use, and c) assists artists to maintain constant pressure with a shading lead.

### BRIEF SUMMARY OF THE INVENTION

The general object of the mechanical shading pencil is to provide a way of assisting artists to stay within a desired area and to create a constant shade. The invention uses a rotating lead, along with eccentric movement of the lead to gain these advantages.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### BRIEF DESCRIPTION OF THE SEVERAL VIEWS OF THE DRAWING

The attached drawings are provided as non-limiting examples of the invention:

FIG. 1—Plan view of the mechanical pencil.

FIG. 2—Half-section view of the mechanical pencil.

### DETAILED DESCRIPTION OF THE INVENTION

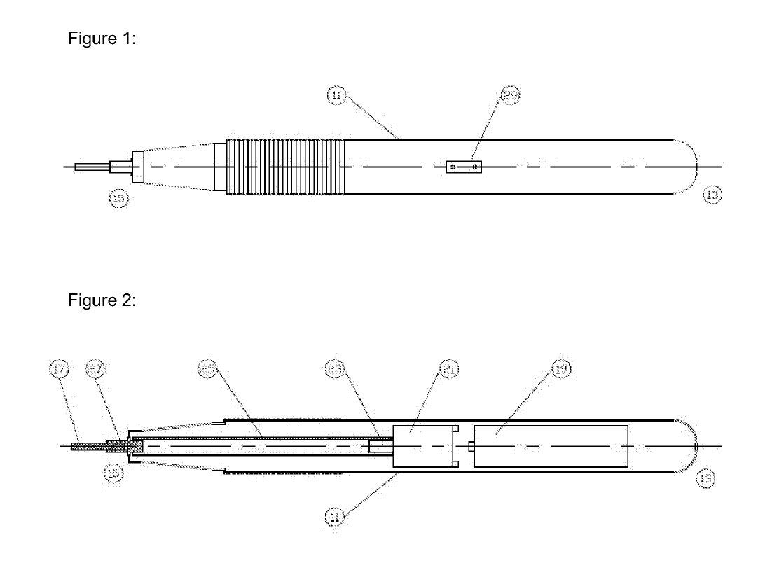

According to the present invention, the foregoing and other objects and advantages are attained by a mechanical pencil as in FIGS. 1 and 2, comprising a pencil casing 11, said casing with a lower writing end 15 and upper end 13. The pencil casing 11 includes a means for eccentrically rotating a pencil lead 17. A typical configuration would include a cylindrical battery pack 19 powering a small electric motor 21, in which said motor's shaft 23 connects to and rotates one end of a shaft extension 25, said shaft extension's other end affixed to a detachable lead holder 27 that holds lead 17.

The lead holder 27, lead 17, and the end of the shaft extension 25 attached to the lead holder 27 forms a floating assembly that is deliberately constructed with flexibility in the shaft extension, allowing the lead to move erratically as it rotates. The shaft extension 25 is fixed by the motor shaft 23 on one end, but the end attached to the lead holder 27 is not rigidly held in place. Because it is floats at the lead holder end, rotation of the lead holder 27 causes it to move erratically.

The movement of the lead holder 27 is bound by the shaft extension's rigidity and the opening in the lower end of the pencil casing 11. If the shaft extension 25 allows the lead to move too widely, the lead holder will brush up against the wall of the pencil's casing 11.

A typical construction would also include an off/on switch 29, and a means of changing the speed of rotation, for example by using a subset of the stack of battery cells comprising the battery pack 19.

Because the lead's writing end is not constrained, but allowed to move erratically as an artist uses the pencil, the lead bounces while rotating. The end result is that the lead naturally shades that portion of the paper on which the shaft spins.

1) A mechanical pencil comprising a pencil body and rotating writing lead, said writing lead with freedom of movement such that it moves erratically as it rotates.

2) An apparatus as in claim 1, in which the pencil's lead rotates only about its own axis.
